(19) United States
(12) Patent Application Publication
(10) Pub. No.: US 2007/0232109 A1
(43) Pub. Date: Oct. 4, 2007

(54) Laptop computer case

(76) Inventors: David H. Parker, Torrance, CA (US); Kevin Deighton, Long Beach, CA (US); John Paul Hoven, Manhattan Beach, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/393,402

(22) Filed: Mar. 29, 2006

(51) Int. Cl. H01R 13/62

(52) U.S. Cl. 439/326

(57) ABSTRACT

A computer case for transporting a laptop computer. The case includes two mating sections and an inner cushioned liner in each section for cushioning the laptop therein in a protective manner. A hinge latch along one side of one section interlocks with a mating hinge latch along one side of the other section to hingedly secure the sections together. A single elongated locking latch is provided on one of the sections, opposite the side where the hinge latch is provided, adapted to lock into a groove on the underside of the other of the sections opposite the side where the other hinge latch is provided.

### BACKGROUND OF THE INVENTION

1. Field of the Invention

This invention relates to protective carrying cases; and, more particularly, to a carrying case for a laptop computer or the like.

2. Related Art

Various types of cases are known for transporting certain devices, such as a laptop computer, in a protective manner. Such cases should be strong and light with a cushioned interior to protect and cushion the computer. The case should unlatch quickly and easily, and one section should be hinged to the other in a manner that will handle repeated opening and closing. Certain prior art cases do not close in any effective manner, nor stand up to vigorous hinging and unhinging. They also do not lock one section to another in a firm locking manner.

### SUMMARY

It is an object of this invention to provide a laptop computer case wherein a first section is hinged to a second section, the sections locking together in a firm locked manner.

It is another object of this invention wherein the foregoing case can be manufactured inexpensively and quickly.

It is still another object of the invention to carry out the foregoing objects wherein the case is cushioned on its interior and can withstand repeated openings and closings.

These and other objects are accomplished by providing a portable laptop computer carrying case comprised of two mating sections that mate about its periphery in a relatively sealed relationship when the sections are closed. An elongated locking latch extends substantially across the entire length of one side of the case on one of the sections and latches into a groove on the underside of the other of the sections. A hinge latch on one of the sections opposite the locking latch interlocks with a hinge latch on the other section opposite the groove for hingedly securing the two sections together.

### DRAWINGS

The above-mentioned features and objects of the present disclosure will become more apparent with reference to the following description taken in conjunction with the accompanying drawings wherein like reference numerals denote like elements and in which:

FIG. 1 is a perspective view of a case in accordance with the invention shown in closed position;

FIG. 2 is a perspective view of the case of FIG. 1 shown in the open position;

FIG. 3 is an exploded view of the case of FIG. 1 prior to assembly thereof;

FIG. 4 is a cross-sectional view taken along lines 4-4 of FIG. 2;

FIG. 5 is a cross-sectional view taken along lines 5-5 of FIG. 1;

FIG. 6 is a view similar to FIG. 5 illustrating the unlatching of the locking latch;

FIG. 7 is a perspective view of a portion of the back side of the case of FIGS. 1 to 6 illustrating how the hinges are pivotally locked to the case; and

FIG. 8 is a rear elevational view of the case of FIG. 7 illustrating how the hinges are locked to the case.

### DESCRIPTION OF THE PREFERRED EMBODIMENT

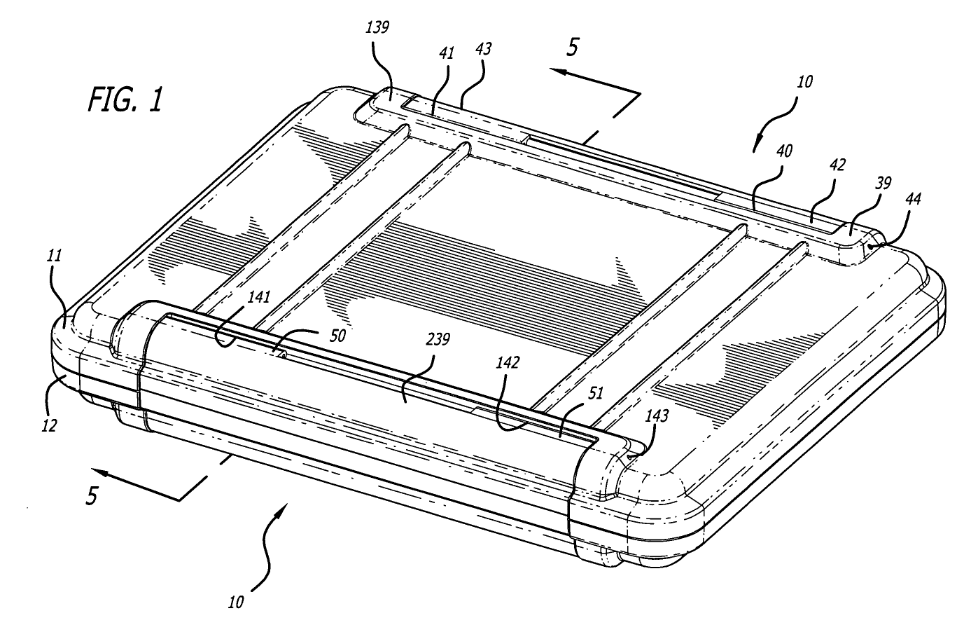

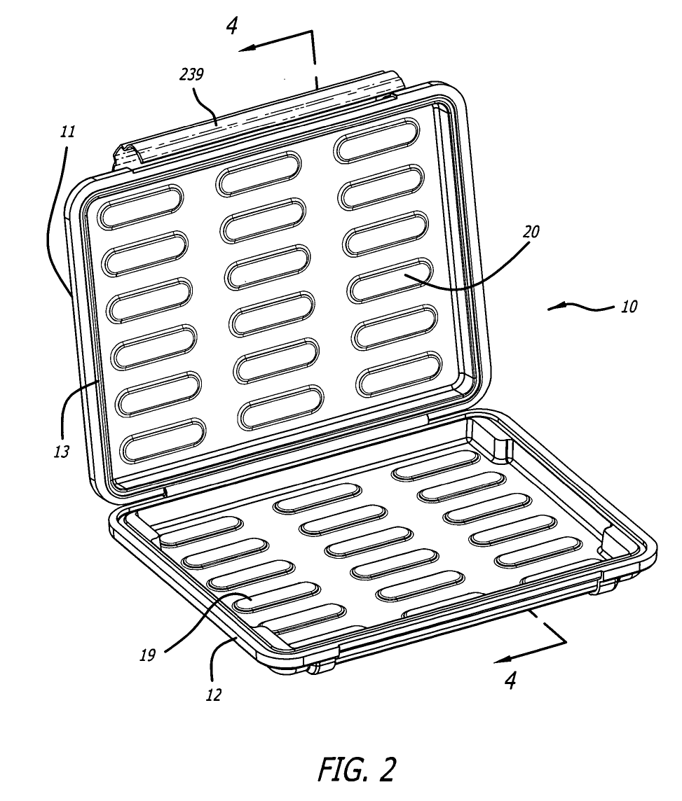

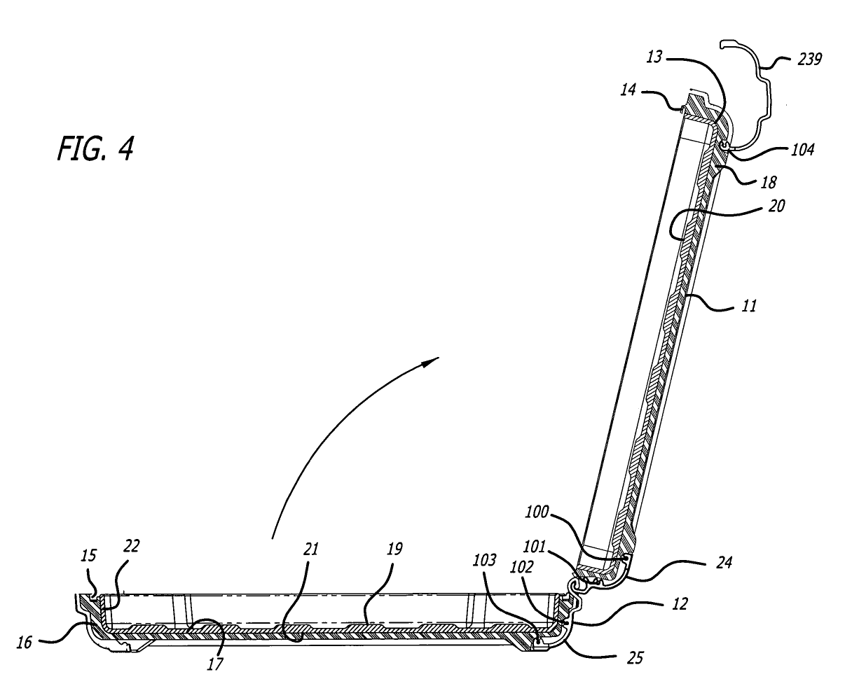

Referring now to FIG. 1 of the drawing, a laptop computer portable carrying case 10 is shown comprised of two mating components or sections 11, 12 (see FIG. 2). The top section 11 includes a peripheral lip 13 (see also FIGS. 4 to 6) extending about its periphery having a downwardly extending peripheral flange 14 (FIG. 4) adapted to engage a peripheral slot 15 in the peripherally extending lip 16 of bottom section 12. This ensures a relatively closed relationship when the top and bottom sections 11, 12 are in the closed FIG. 1 position.

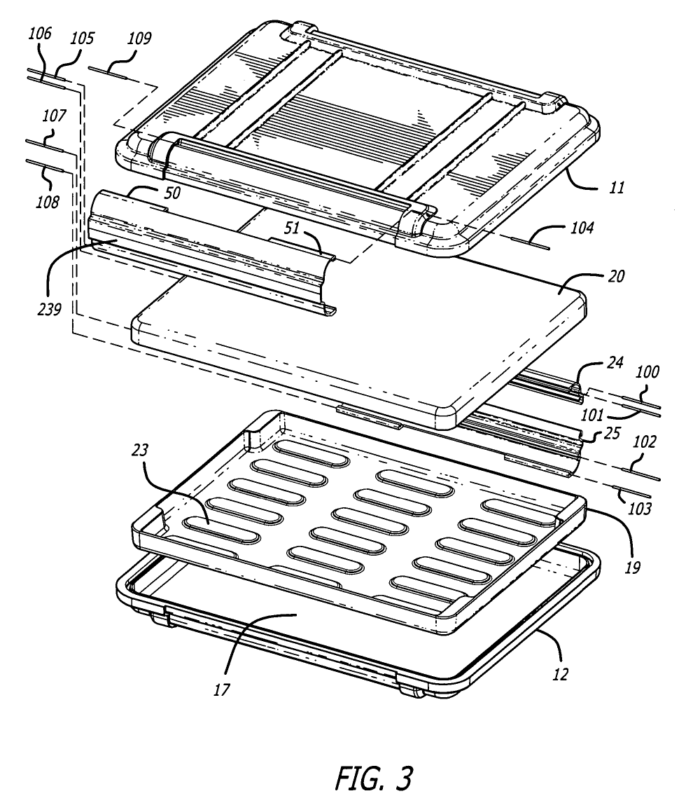

As seen in FIG. 3, each section 11, 12 has an inner space 17, 18 (see also FIG. 4) into which liners 19, 20 fit, such as spaces 17, 18, respectively (see also FIGS. 4 to 6).

Liners 19, 20 fit into spaces 17, 18 and each liner has a base 21 (FIG. 4) and an inner peripheral wall 22. Each liner 19, 20 is shaped to conform substantially to the interior of sections 11, 12 as shown.

Each liner 19, 20 has a plurality of spaced ridges 23 (FIG. 3) on its upper surface and may be made of a suitable high density foam material.

A plurality of locking pins 100 through 109 are provided to lock the hinges and locking latch, as will be discussed, to case 10 in a pivotal relationship.

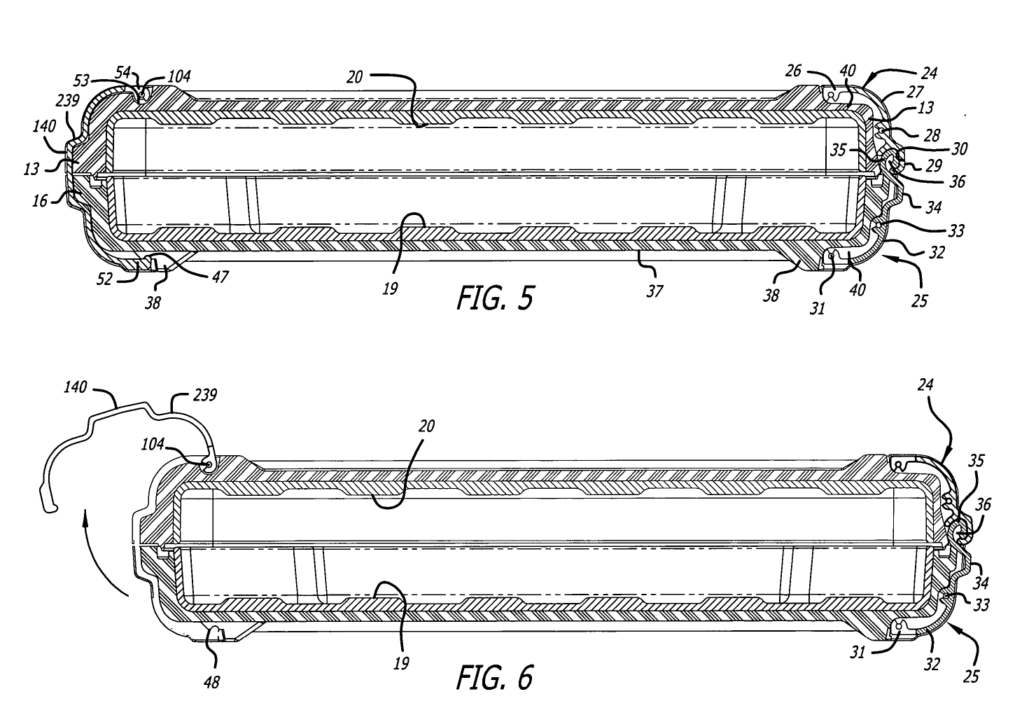

The sections 11, 12 may be made of any suitable rigid material, such as polycarbonate plastic, steel, aluminum, etc. The sections 11, 12 may be generally rectangular comprised of 2 long sides interconnected to 2 shorter sides as shown. As particularly contemplated in the present invention, a pair of interlocking hinges 24, 25 (see also FIGS. 5 and 6) extending substantially along one long side of each section 11, 12.

Hinge 24 has a first slotted apertured end 26 (FIG. 5) integral with a first curved portion 27 terminating in a second integral slotted apertured portion 28 integral with a curved generally semi-circular end 29 having a opening 30 therein. Hinge 25 has a first slotted end 31 integral with a first curved portion 32 terminating in a second integral slotted apertured portion 33 integral with a trapezoidally shaped portion 34 extending to and integral with a curved generally semi-circular end 35 having an opening 36 therein. As seen in FIG. 5, the degree of curvature of end 35 may be greater than the degree of curvature of end 29.

Each section 11, 12 may be essentially similar so that the bottom wall 37, of, for example, section 12, may have supporting legs 38 at each corner.

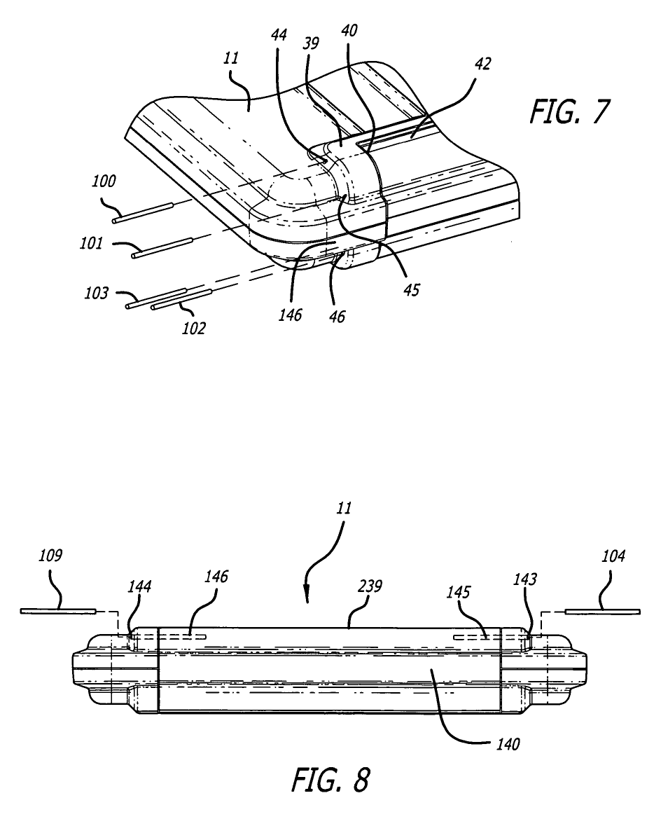

As seen in FIGS. 1 and 7, the back of each section 11, 12 has molded-in raised spaced portions, such as portions 39, 139, respectively, with spaced elongated cut-outs or slots 40, 41 (see FIG. 1). Each hinge 24, 25 has an extension portion, 42, 43, respectively, conforming to slots 40, 41, respectively.

Holes 44, 45, 46, 146 (only one side visible in FIG. 7—see also FIG. 8) align with holes (not shown) in each flange 24, 25 for receiving locking pins 100 through 103 therein in tight fitting locking manner. Pins 105 through 108 (see FIG. 3) on the opposite side are received in the aligned holes in the same manner.

When case 10 is opened from the FIG. 1 to the FIG. 4 position, hinges 24, 25 remain interlocked and attached to case 10 by pins 100 through 103 and 105 through 108, FIG. 3, and their interlocking engagement. That is, hinge 24 interlocks at curved portion 29 with the curved portion 35 of hinge 25, as shown in FIG. 4.

Locking latch 239 (FIG. 3) extends substantially along the front of case 10 as shown and has a curved end portion 54 (FIG. 5) disposed in groove 53 in top section 11. Latch 239 has an intermediate raised center portion 140 which conforms to the mating lip portions 13, 16 of top and bottom sections 11, 12. As seen in FIG. 1, top section 11 has a pair of spaced cut-out slots 141, 142 on each side receiving pins 104, 109 (FIG. 8) through aligned holes 143, 144, in top section 11 on each side of slots 141, 142 aligned with holes 145, 146 respectively (FIG. 8), in flange portions 50, 51 of latch 239 (see FIG. 1). This locks the latch 239 to upper case section 11 in a pivotal manner.

The bottom of latch 239 may have an elongated raised nub 47, FIG. 5, adapted to snap fit into a like configured groove 48, FIG. 6, on the underside wall 37 of bottom section 12 adjacent front leg 37 of bottom section 13. In this matter, locking latch 239 can be snapped out of engagement with groove 48 and moved from the FIG. 5 position to the FIG. 6 position to unlock latch 239 which pivots about pins 104, 109.

Top section 11 can then be thus pivoted to the open FIG. 4 position.

The flanges 50, 51 (FIG. 3) on latch 239 cooperate to give an effective locking pressure distributed across the front of case 10. The lower end 52 (FIG. 5) of latch 239 can be quickly and easily grasped at any desired location along the bottom thereof to unsnap the nub 47 out of groove 48.

Although single unitary liners 19, 20 are disclosed, obviously such liners may be provided in sections or cut to conform to the desired components carried by case 10.

Although the case 10 is preferably used to carry a laptop computer, obviously it can be used to carry any suitable device for which cushioned protection is desired.

Although a particular embodiment of the invention is disclosed, variations thereof may occur to an artisan and the scope of the invention should only be limited by the scope of the appended claims.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

I claim:

1. A carrying case comprising:
a main body portion including a pair of mating sections, each of said sections having a front side and a rear side, one of said sections forming the top of said case and the other of said sections forming the bottom of said case;
a locking latch pivotally connected along the front side of one of said sections adapted to lock to the underside of the front side of the other of said sections; and
each of said sections having an elongated hinge pivotally connected to the rear side thereof, said elongated hinges being interlockingly engaged and pivotal about one another whereby, when said locking latch is unlocked, said top section can be moved away from said bottom section into an open position.

2. The case of claim 1 wherein each of said hinges includes a pair of spaced flange portions disposed in a pair of spaced slots in each of said sections at the rear sides thereof.

3. The case of claim 2 wherein all of said flange portions conform to its respective slot.

4. The case of claim 3 including a plurality of spaced holes extending through said top and bottom sections of said case inwardly toward said slots on opposite sides of said sections and aligned with a like plurality of spaced holes in said flange portions, and locking pins extending through said aligned holes in said sections and said flange portions.

5. The case of claim 1 including a locking latch releasably locking the top section of said case to the bottom section thereof at the front side of said case.

6. The case of claim 1 wherein said locking latch is pivotally mounted to said top section.

7. The case of claim 6 wherein said locking latch curved configuration extending over the front of said case when said top section is closed with respect to said bottom section and said locking latch terminating under said bottom section when in the latched locked position in an elongated nub snapfitting into a like configured groove on the underside of said bottom section adjacent the front side thereof.

8. The case of claim 1 wherein the hinge of said top section has a first slotted apertured end integral with a first curved portion terminating in a second integral slotted portion integral with a curved generally semi-circular and having a opining therein, and hinge of said bottom section having a first slotted end integral with a first curved portion terminating in a second integral slotted apertured portion integral with a trapezoidally shaped portion extending to an integral with a curved generally semi-circular end having an opening therein, said curved generally semi-circular end of said hinge on said bottom section being disposed in, and interlocking to, the opening in said semi-circular end of said hinge on said top section.

9. The case of claim 8 wherein the degree of curvature of the semi-circular end of said hinge on said bottom section is greater than the degree of curvature of said semi-circular end of the hinge of said top section.

10. The case of claim 8 wherein said first slotted end of said hinge and said second slotted portion of said top section are pivotally connection to said case.

11. The case of claim 10 wherein said first slotted end and said slotted apertured portion of said hinge of said bottom section are pivotally connected to said case.
